(19) United States
(12) Patent Application Publication
(10) Pub. No.: US 2008/0148218 A1
(43) Pub. Date: Jun. 19, 2008

(54) MASK DATA GENERATION METHOD, MASK FORMATION METHOD, PATTERN FORMATION METHOD

(75) Inventors: Yukiya KAWAKAMI, Kanagawa (JP); Atsushi Yamamoto, Kanagawa (JP); Youji Tonooka, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 11/959,610

(22) Filed: Dec. 19, 2007

(30) Foreign Application Priority Data
Dec. 19, 2006 (JP) 2006-340738

(51) Int. Cl. G06F 17/50

(52) U.S. Cl. 716/21

(57) ABSTRACT

There is provided an OPC method for obtaining a desired shape in the area where accuracy is required in the case where the area where OPC accuracy is required and the area where no/little OPC accuracy is required are adjacent. At the boundary part between the area where OPC accuracy is required and the area where no little OPC accuracy is required, the area where accuracy is required is enlarged by an area suitable for the area with high accuracy, and the area where no/little accuracy is required is contracted by the area suitable for the area with high accuracy thereafter to perform OPC calculations corresponding to accuracies with respect to respective areas to thereby obtain a desired pattern.

### BACKGROUND OF THE INVENTION

1. Field of the Invention

The present invention relates to an optical proximity correction method in manufacturing a semiconductor device.

2. Description of the Related Art

By development of recent semiconductor manufacturing technology, semiconductor integrated circuits with minimum feature size 65 nm or less are manufactured. Such a fine processing has been realized followed by enhancement of fine pattern formation technology such as mask process technology, optical lithography technology and etching technology, etc. In devices of the design rule with pattern size sufficiently larger than wavelength of light where exposure by i-line/g-line can be used, a plane shape of an LSI pattern desired to be formed on wafer was transferred onto an exposure mask as it is to further transfer the completed mask pattern onto the photoresist layer over the wafer by an optical projection system. The target layers (e.g., semiconductor substrate, semiconductor film, insulator film, conductor film) which are located below the mask pattern so that LSI patterns to satisfy the design dimensions can be formed on the wafer substantially every part. However, as semiconductor manufacturers move their processes to finer design rules, it has been difficult to transfer/form patterns with high fidelity in respective processes. As a result, there has taken place the problem that the final Critical Dimension (CD) failed to reproduce the Critical Dimension (CD) of the original LSI pattern.

Particularly, in lithography and etching processes which are most important for attaining fine pattern formation, critical size accuracy (CD accuracy) of a target pattern has been greatly changed depending upon other pattern layouts disposed at the periphery of patterns desired to be formed. In view of the above, in order to suppress such a change so that each processed dimension becomes equal to desired value, there has been used Optical Proximity Correction (OPC) technology to deform edge or corner part of mask pattern subject to such a change.

At present, since an LSI pattern that a designer has prepared and a mask pattern used at the time of exposure are greatly different from each other with complication of the optical proximity correction (OPC) technology, it has been impossible to easily predict completed pattern shape on wafer. For this reason, OPC is applied to mask pattern in accordance with the following procedure.

First, measured value (measured CD) at a sample mask pattern and a calculated value (calculated CD) are driven to coincide with each other by using the experimental simulation so that simulation model is prepared. Since the simulation model can predict completed pattern shape on wafer of an arbitrary LSI pattern as long as there are employed the exposure condition/the etching condition which are the same as those of the sample mask pattern in principle, completed pattern shape on wafer after selected OPC technique has been applied is calculated, thereby making it possible to confirm whether or not corresponding OPC is suitable. In view of the above, in a technique (rule-based OPC) to change original pattern into a set of edges on the basis of several conditions to slightly shift positions of those individual edges thus to implement OPC, the shape is verified by using the above-mentioned experimental simulation to confirm that there do not exist problems such as short-circuit, breakage of wire, too narrowing and/or too widening etc. Thereafter, masks for manufacturing LSI products are prepared.

Further, there is a technique (model-based OPC) to change original pattern into a set of edges on the basis of a simulation model to slightly shift positions of those individual edges to look at the completed pattern shape for a second time to repeat trial and error so that desired shape or desired CD can be routinely obtained. With this technique, if the accuracy of the simulation model is high and the completed pattern on wafer can be precisely predicted, employment of this technique means that it is possible to completely control CD on wafers.

In the model-based OPC, there are two factors relating to OPC accuracy. One factor is accuracy of simulation model, and the other factor is the number of repetition times of trial and error. Improvement in accuracy of the simulation model substantially leads to an increase in calculation time. Moreover, since even if the OPC calculation is performed, partial size to be desired cannot be obtained once, it is necessary to perform the OPC calculation again to repeat trial and error until there results a desired CD. Also in this case, it is a matter of course that the calculation time increases in proportion to the number of repetition times. It takes several days occasionally for calculation to perform OPC according to the pattern of LSI, even if a high speed calculation machine is used. When pursuit of accuracy is performed, there results an increase in calculation time so that the design efficiency of mask would be lowered.

In view of the above, for the purpose of reducing the calculation time, various techniques have been devised. In the Japanese Patent Laid-Open No. 2002-341514, there is disclosed a method of dividing plural patterns prescribed by design data into layouts or shapes thereafter to perform correction thereof. Moreover, in the Japanese Patent Laid-Open No. 2002-055431, there is disclosed a method of performing, on the basis of design layout data, division between areas where OPC is performed and areas where no OPC is performed to perform OPC processing. In WO 2005/024519, there is disclosed an OPC processing to adjust sizes of the area where OPC is performed and the area where no OPC is performed.

However, the inventor of the present invention has noticed that there are the following problems. In the case of performing area division on the basis of design data to perform OPC processing as in the case of the methods disclosed in the Japanese Patent Laid-Open No. 2002-341514 and the Japanese Patent Laid-Open No. 2002-055431, processing are performed every area. However, in the methods disclosed in these related arts, in the case where an area where OPC accuracy is required and an area where no/little OPC accuracy is required are adjacent, there were the cases where the influence of the area with low accuracy is exerted so that a desired OPC pattern fails to be obtained within the area where accuracy is required.

### SUMMARY

A mask data generation method of the present invention includes: dividing design data relating to exposure mask into pattern layout data and area layout data; classifying the area layout data in accordance with accuracy; enlarging an area with high accuracy into an area with low accuracy at a boundary part of accuracy of the area layout data by an area suitable for the area with high accuracy within a range which is smaller than the maximum value of an influence range of proximity effect, and contracting the area with low accuracy by the area suitable for the area with high accuracy to thereby perform adjustment of the area layout data; and performing, with respect to the area after area adjustment, optical proximity correction based on accuracy of the area. Here, enlargement and contraction corresponding to the area suitable for the area with high accuracy are determined in accordance with a correction quantity of proximity effect at the boundary part of the area with high accuracy.

In the case of forming a pattern existing in the vicinity of the boundary between the high accuracy area and the low accuracy area of area layout data, it is possible to form, with good accuracy, a pattern existing in the high accuracy area in the vicinity of the boundary between the high accuracy area and the low accuracy area.

### BRIEF DESCRIPTION OF THE DRAWINGS

The above and other objects, advantages and features of the present invention will be more apparent from the following description taken in conjunction with the accompanying drawings, in which:

FIG. 1 is a diagram showing flow of a mask data generation method of an embodiment 1;

FIG. 2 is a diagram showing a portion of flow of the mask data generation method of the embodiment 1;

FIG. 3 is a diagram showing flow of a mask data generation method of an embodiment 2;

FIG. 4 is a diagram showing a portion of flow of the mask data generation method of the embodiment 2;

FIG. 5 is a diagram showing another portion of flow of the mask data generation method of -the embodiment 2;

FIG. 6 is a diagram showing flow of a mask data generation method of a modified example of the embodiment 2;

FIG. 7 is a diagram showing flow of a mask data generation method of an embodiment 3;

FIG. 8 is a diagram showing a data preservation method of the embodiment 3;

FIG. 9 is an explanatory view of a repeating pattern part of pattern layout;

FIG. 10 is an explanatory view of a repeating pattern area and a no-repeating pattern area;

FIG. 11 is an explanatory view of calculation area setting;

FIGS. 12(a) and 12(b) are diagrams showing the relationship between pattern and layout of the present invention;

FIG. 13 is a diagram showing the relationship between pattern and layout of the present invention;

FIGS. 14(a) and 14(b) are diagrams showing the relationship between pattern and layout of the present invention;

FIG. 15 is an applied example to a contact hole;

FIG. 16 is an applied example to a dot pattern;

FIG. 17 is an explanatory view of area layout;

FIG. 18 is an explanatory view of repeating pattern area layout; and

FIG. 19 is an explanatory view of pattern layout data.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Preferred embodiments of the present invention will now be described with reference to the attached drawings. In all drawings, similar reference numerals are respectively attached to similar components, and their description will be omitted as occasion demands.

### First Embodiment

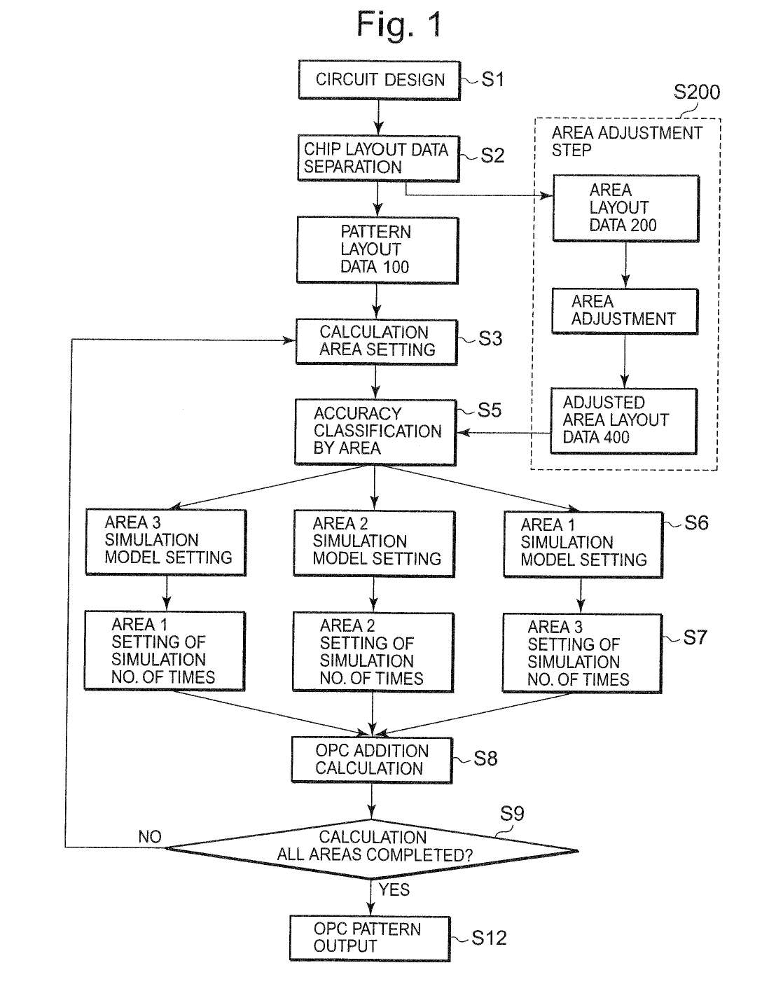

FIG. 1 is a diagram showing a mask data generation flow according to the embodiment 1 of the present invention. In a practical sense, this mask data generation flow indicates steps from preparation of circuit design data up to OPC pattern output.

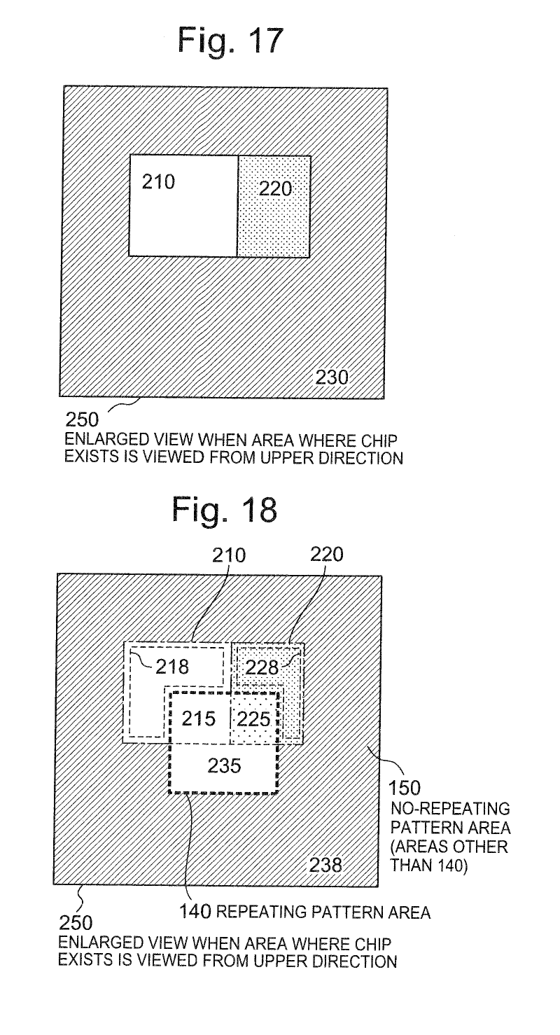

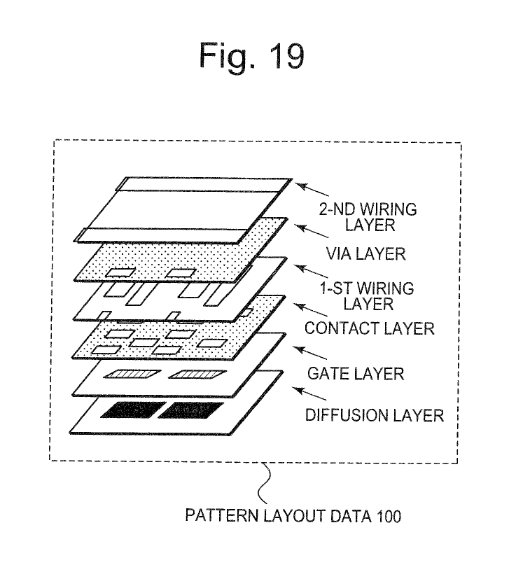

First, chip layout data for exposure mask is generated by circuit design (step 1: S1). This data includes area layout data based on functions at a finally completed chip shown in FIG. 17, and pattern layout data (FIG. 19) including patterns every respective layers based on processes for forming respective functions. Here, as area layout data, in FIG. 17, there are shown a temporary layout 210 of an area 1 (high accuracy required area), a temporary layout 220 of an area 2 (where accuracy is required to a certain degree), and a temporary layout 230 of an area 3 (accuracy unnecessary area). These areas respectively correspond to, e.g., a transistor area (Tr area), a decoupling capacitor area (DC area), and a dummy area (Dummy area) on a chip. It is not limited that these areas are necessarily divided into three areas, but setting may be made such that there results a suitable number of areas depending upon accuracy or function. Moreover, in the pattern layout data, there are included patterns every layer such as diffusion layer, gate layer and contact layer, etc.

Pattern layout data 100 and area layout data 200 are separated from the chip layout data (FIG. 1; Step 2: S2).

Calculation area setting is performed with respect to the pattern layout data (step 3: S3). This calculation area setting is to perform division by setting of coordinates 130 in XY-directions with respect to the pattern layout 100 to set an area to be calculated (FIG. 11) Ordinarily, this fragment 120 is called Ambit, etc., and depends upon the design rule, e.g., a square area of about 1 μm in the case of 90 nm rule. As previously described, OPC is optical proximity correction, wherein there exist a distance where proximity effect is exerted. This distance is the previously described Ambit. Namely, there is the characteristic that OPC away, by one Ambit, from the part where OPC is performed from now on does not affect current part where OPC is performed.

Area adjustment step 200 is performed with respect to the area layout data separated in the step 2 (S200). The area adjustment step is a step of performing adjustment of an area of temporary layout to suitably set the boundary of layout to determine adjusted area layout data. Here, the area adjustment step 200 will be first described on the basis of actual pattern.

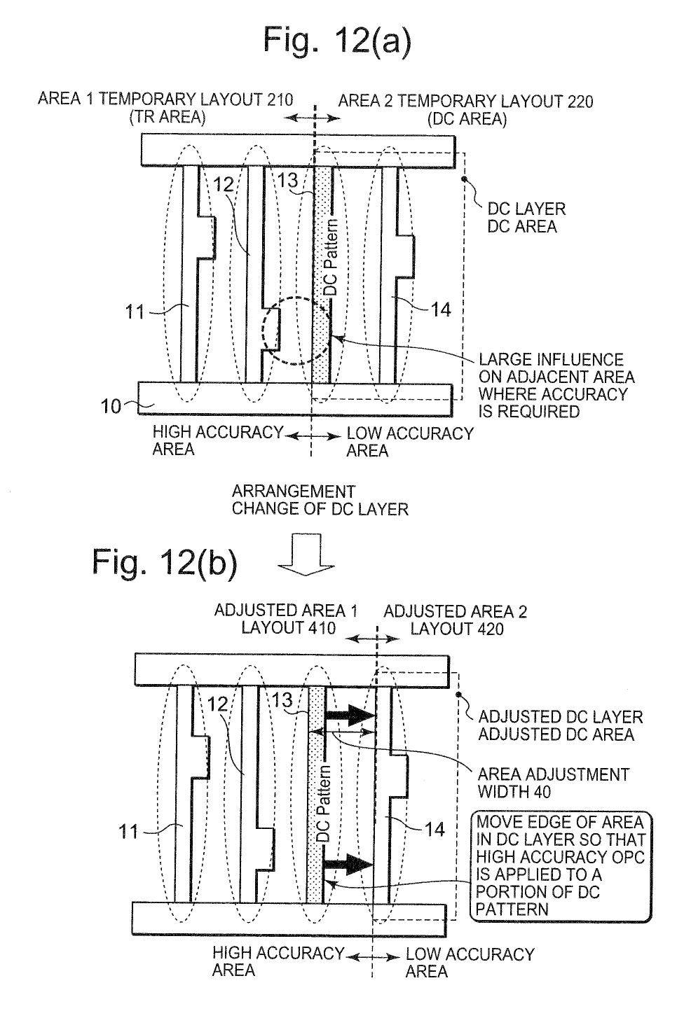

FIG. 12 is a diagram for explaining a method, to which the present invention is applied, to form gate pattern 10 on the boundary between area layouts 210, 220 where accuracies are different from each other. In the area adjustment step 200, as shown in FIG. 12(a), for example, the outer peripheral part of the temporary transistor area 210 is enlarged by a predetermined area at the boundary between the transistor area corresponding to the temporary layout 210 of the area 1 and the decoupling capacitor area corresponding to the temporary layout 220 of the area 2. Here, the predetermined area is an area where the outer periphery is enlarged/contracted on the basis of area adjustment width 40 such as minimum space width, cell dimensions, pitch, etc. The area adjustment width is a value determined by the design rule, and is set as a value which is integral multiple, e.g., 1 to 5 times thereof. The area adjustment width does not reach Ambit size so that it becomes equal to a value which is one several number-th. This is because the area adjustment width falls within Ambit in the case of 90 nm rule, 2 to 2.5 area adjustment widths fall in the case of linear line shape, and 8 to 9 area adjustment widths fall in the case of contact or dot.

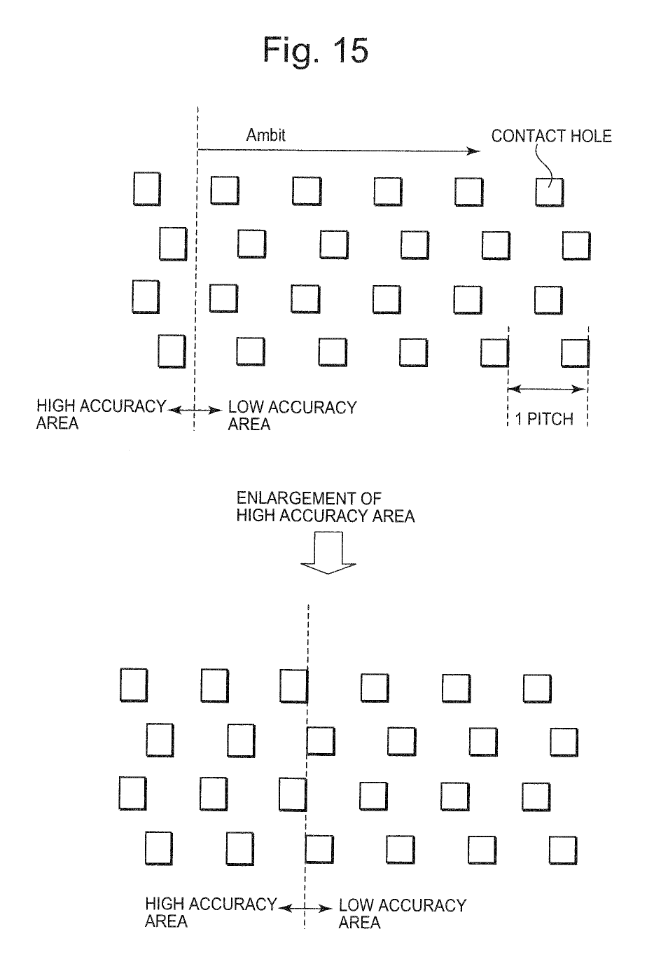

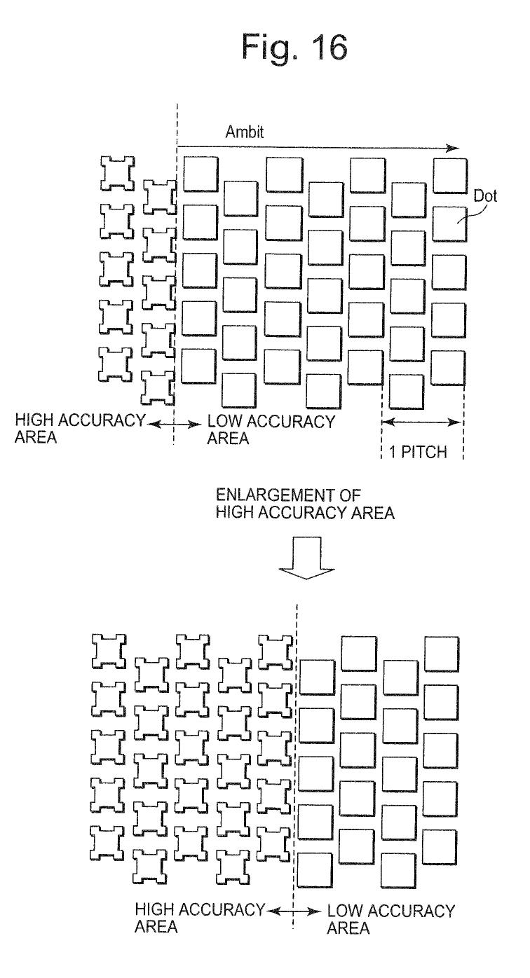

Setting of the area adjustment width is performed by exposure condition in using, for exposure, mask prepared in the present embodiment and accuracies of respective area layout data. In this case, it is sufficient to enlarge an area by a predetermined size which does not reach the magnitude of the maximum value of the influence range of optical proximity effect, e.g., about one pitch within two pitches in the case of a shape such that several linear lines are arranged, about one to two within two pitches in the case where contact holes are arranged as shown in FIG. 15, and about one to two patterns within two pitches in the case of pattern like dots nearly to resolution limit as shown in FIG. 16. Particularly, this is because the outermost part of the enlarged area, i.e., the part which does not primarily require accuracy serves as a buffer area between the inner part where accuracy is required and the outer part thus to continuously connect two areas.

For example, the area layout corresponding to the transistor area is enlarged by one pitch at the minimum, and is enlarged by two pitches in the case where accuracy does not reach a predetermined value, and the decoupling capacitor area is contracted accordingly. Next, the decoupling capacitor area can be enlarged by the minimum space width and the dummy area can be contracted. On the other hand, in accordance with enlargement of the temporary layout 210 of the area 1, the temporary layout 220 of the adjacent area 2 is contracted by an enlarged predetermined area. In this way, the area adjustments of the layout 410 of the area 1 after area adjustment and the layout 420 of the area 2 after area adjustment are performed (FIG. 12(b)). Here, the pitch is a part from the left end of a certain pattern to the right end of a next pattern as shown in FIGS. 15 and 16.

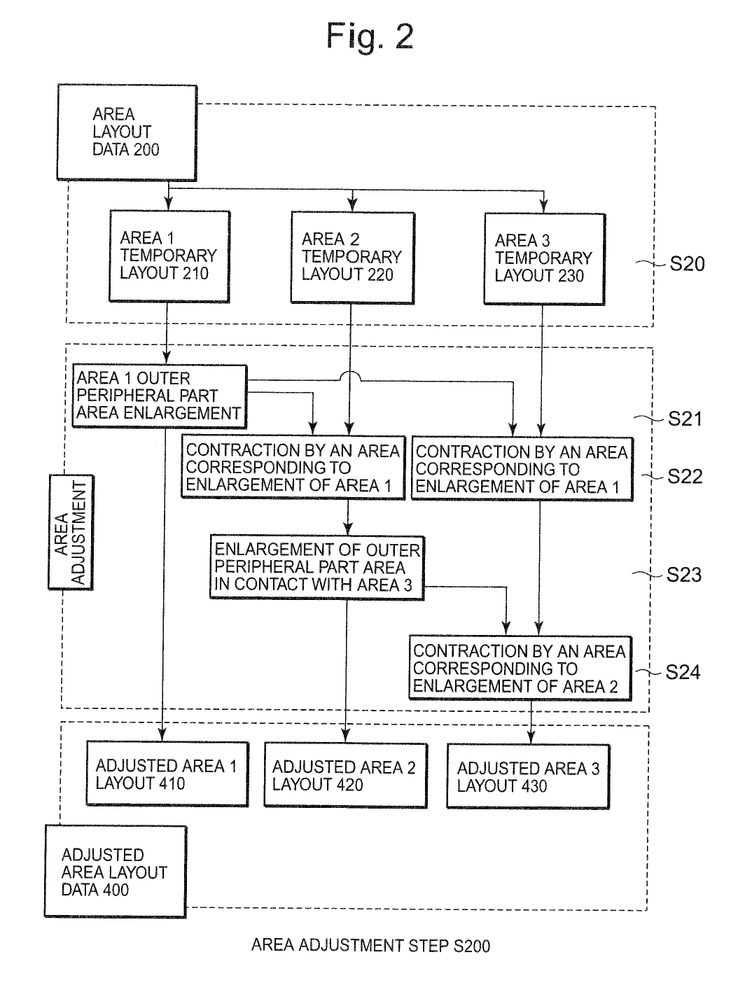

The area adjustment step 200 will be described with reference to FIG. 2. In dependency upon accuracy and function, the area layout data 200 is classified into, e.g., temporary layout data 210 of area 1, temporary layout data 220 of area 2, and temporary layout data 230 of area 3 (step 20: S20). The temporary layout data 210 of the area 1 is enlarged by a predetermined area (step 21: S21) so that layout data 410 of the area 1 after area adjustment is provided. In accordance with the area enlargement of the temporary layout 210 of the area 1, the temporary layouts of the areas 2 and 3 are contracted (step 22: S22). Next, the temporary layout data of the area 2 is enlarged by a predetermined area (step 23: S23) so that layout data 420 of the area 2 after area adjustment is provided. The temporary layout data of the area 3 is contracted by a predetermined area so that layout data 430 of the area 3 after area adjustment is provided. Also in the case where there exist three areas or more, there will be repeated, in a manner similar to the above, an area adjustment such that an area with high accuracy is enlarged, and an adjacent area with low accuracy is contracted. It is not necessary that predetermined areas where enlargement/contraction is performed have all the same width, but are set in accordance with accuracy.

The step 5 of performing accuracy classification of fragment divided in the step 3 on the basis of the adjusted area layout data 400 which has been adjusted in the area adjustment step 200 will now be described. Description will be made with reference to FIG. 12 again. By performing the area adjustment step 200, there are obtained area layout data 410 after area adjustment and area layout data 420 after area adjustment which are shown in FIG. 12(b). At this time, gate pattern 10 is divided on the basis of calculation area setting step of the step 3, e.g., every one Pixel (one a certain integral number N-th of 1 Ambit: N is 5 to 20) as processing unit of calculation (fragment) so that division numbers are attached. In this step, assignment is made such that this fragment belongs to what accuracy area on the area after area adjustment. This means that linear line area 13 of the gate pattern 10 exists at temporary layout 220 of area 2 in FIG. 12(a) before area adjustment, but exists at temporary layout 410 of area 1 after area adjustment. After accuracy classification of the step 5, correction of higher accuracy is performed with respect to linear line area 13 in order to perform correction pattern formation step suitable every area as described later.

Returning to the description of the flow of FIG. 1, division numbers are attached to pattern layout data 100 over the entire area as shown in FIG. 11 in step 3, and the accuracy classification of these fragments is performed, in order, in step 5 so that simulation model corresponding to the area is set (step 6: S6). Number of repetition times of simulation is set (step 7: S7). Thus, OPC calculation is performed (step 8: S8).

After OPC calculation is completed with respect to fragment of division number 1 in step 8, determination as to whether or not fragment to be calculated is left is performed (step 9: S9). Since the fragment to be calculated is left after calculation of fragment of division number 1, fragments of division numbers 2, 3, 4 . . . are set as fragment to be calculated in calculation area setting so that steps 5 to 8 are performed. Thus, OPC calculations corresponding to respective area accuracies are performed. The calculated results of fragments are reflected, in order, with respect to position located at original fragments.

When it is determined in step 9 (S9) that there is no pattern to be calculated, OPC pattern is outputted (step 12: S12). Thus, mask data is prepared by the outputted OPC pattern. On the basis of this mask data, patterns are prepared and exposure masks are prepared on a mask substrate. Next, resist film is coated over a substrate which is formed some devices such as transistor, etc. By exposing this resist film by using the prepared exposure mask, resist pattern is formed. By performing etching using this mask, patterns are formed.

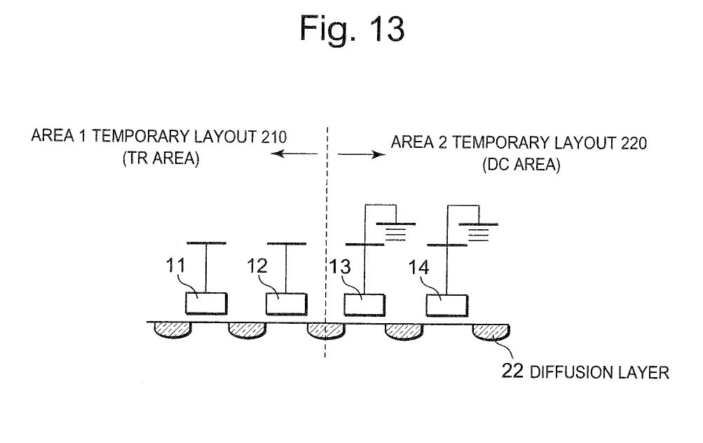

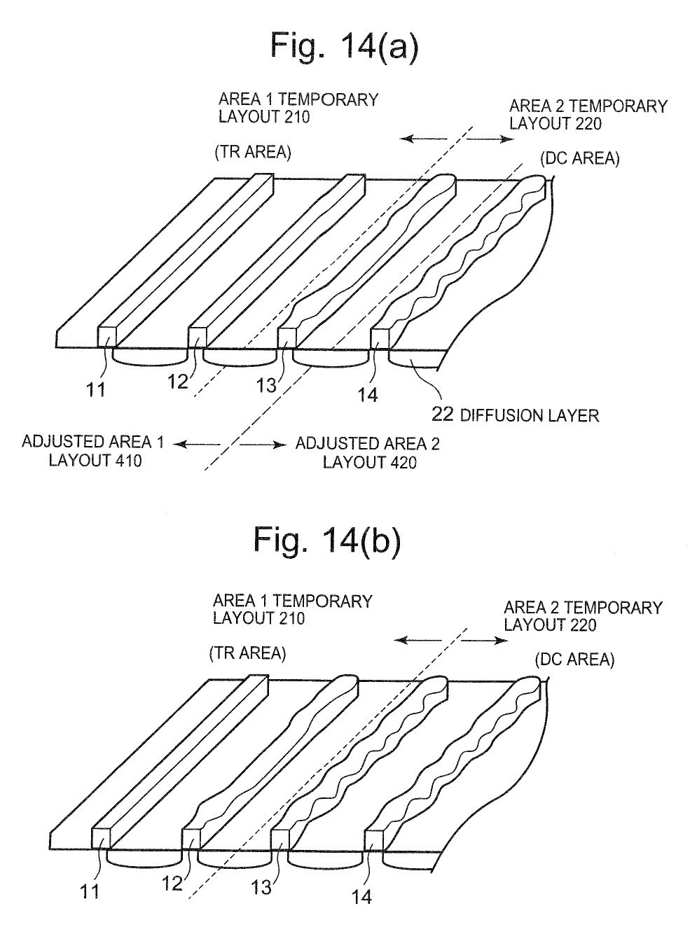

The advantage of the present embodiment will be described with reference to FIGS. 12 to 14. FIGS. 13 and 14 show devices and patterns formed on the semiconductor substrate which respectively corresponds to linear line areas 11 to 14 of the gate pattern 10 of FIG. 12. FIG. 14 shows, in a practical sense, the area of the minimum pitch within semiconductor device in which a gate insulating film and a gate electrode film are formed on a substrate where device isolation (not shown) is formed to prepare gate pattern and to form diffusion layer area. FIG. 13 is a diagram showing the relationship by functions of the gate pattern and devices of area. In the case where the gate pattern 10 exists within the transistor area, the linear line area of the gate pattern actually serves as the gate of transistor. In the case where the gate pattern 10 exists within the decoupling capacitor area, the linear line area of the gate pattern operates as an electrode of decoupling capacitor in practice. In such a case, accuracy as high as transistor is not required for linear line areas 13 and 14 of the gate pattern corresponding to the decoupling capacitor part.

In the related art Publication, there is disclosed a method of performing such a correction in which areas as stated above are taken into consideration. However, in practice, when division by cutting is performed as it is at the boundary part, the influence with respect to OPC processing at the part where high accuracy is required as in the linear line area 12 of the gate pattern as shown in FIG. 14(b), for example, cannot be disregarded. Here, when this embodiment is applied, high accuracy correction pattern can be obtained in a short time also at the part which is high accuracy and is affected from the lower accuracy part as shown in FIG. 14(a). Thus, a transistor for which higher accuracy is required as the electric characteristic can be formed in order that the influence from the decoupling capacitor area for which higher accuracy is not required is not affected. Accordingly, as shown in FIG. 14(a), in the transistor area where accuracy is required, pattern serving as gate electrode is formed up to the end thereof with substantially uniform processing accuracy. Conversely, in the decoupling capacitor area where it is sufficient that accuracy is low, processing accuracy becomes lower to some extent in the vicinity of the boundary of the area as compared to the pattern of the transistor area. Thus, there is formed a semiconductor device in which decoupling capacitor is formed as a low accuracy pattern within the decoupling capacitor area. Here, the part with slightly lower processing accuracy (i.e., linear line area 13), corresponds to the area where the area adjustment has been performed.

Moreover, in the related art Publication 3, enlargement processing of magnitude of the maximum value of the influence range of the optical proximity effect (Ambit referred to as in the invention of this Application) is performed. In the case where it is sufficient that the OPC processing is performed once, there is no problem in the case where an approximately enlarged area is also included. However, when attempt is to seek for accuracy of OPC, there results a repetition to perform OPC processing to perform development simulation to change the OPC processing on the basis of the development simulation to perform development simulation for a second time. As a result, there takes place the problem that OPC is unnecessarily applied to an area where no accuracy is necessary to elongate the calculation time. As the result of the fact that the enlarged area is variously adjusted to perform trial action, it has been found that there is no necessity that the area where such repetitive calculation is performed twice or more is enlarged up to the magnitude of “the maximum value of the influence range of optical proximity effect” (Ambit referred to as in the invention of this Application). For this reason, as the result of the fact that the method of this embodiment was tried with respect to several patterns, the calculation time in the case where such an area has been broadened by the previously described predetermined area can be shortened by 40% at the maximum with respect to the calculation time in the case where such an area is broadened up to the magnitude of “the maximum value of the influence range of the optical proximity effect” (Ambit referred to as in the invention of this Application). Since there are instances where calculation may require several days, this difference is large.

### Second Embodiment

In FIG. 17 which is a diagram of area layout data, there exist repeating pattern area 140 including temporary layout 215 of repeating pattern area 1, temporary layout 225 of repeating pattern area 2 and temporary layout 235 of repeating pattern area 3; and no-repeating pattern area 150 including temporary layout 218 of no-repeating pattern area 1, temporary layout 228 of no-repeating pattern area 2 and temporary layout 238 of no-repeating pattern area 3 as shown in FIG. 18. The repeating pattern area is an area where, e.g., specific transistors, decoupling capacitors and dummy patterns are repeated. The repeating pattern area 140 is a part such that plural unit cells exist there within, and areas except therefor are no-repeating pattern area 150. Moreover, repeating/no-repeating data of transistors, decoupling capacitors and dummy areas are included in cell units, for example also in the pattern layout data.

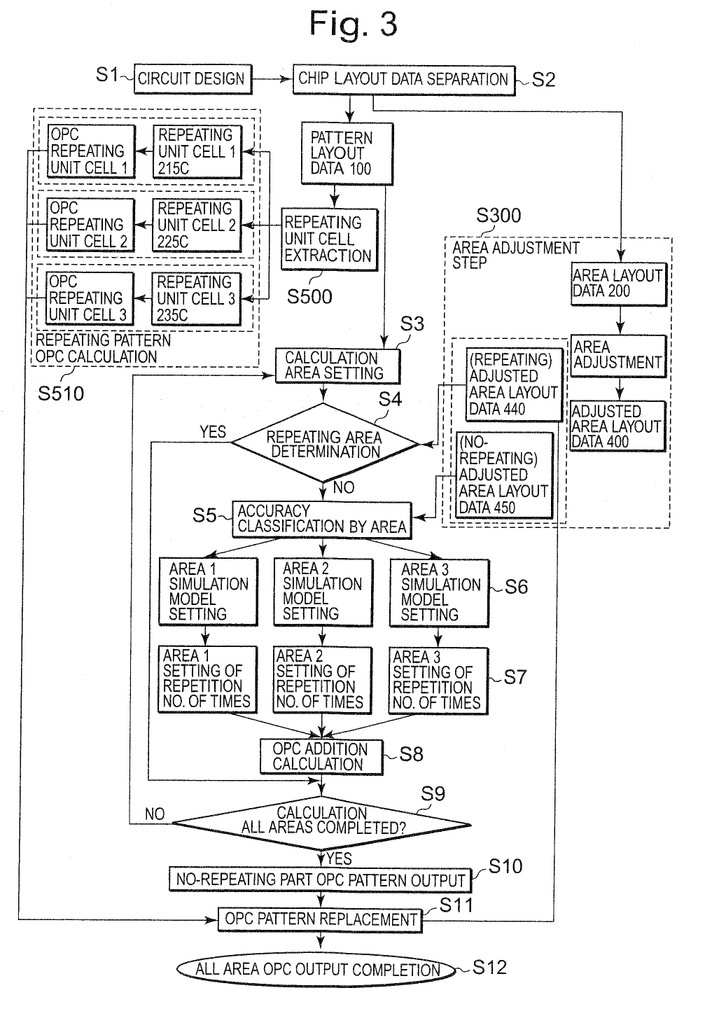

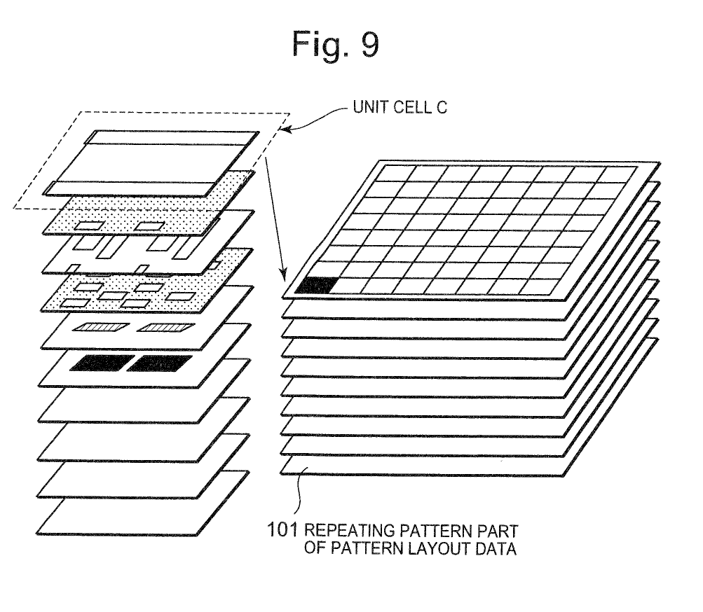

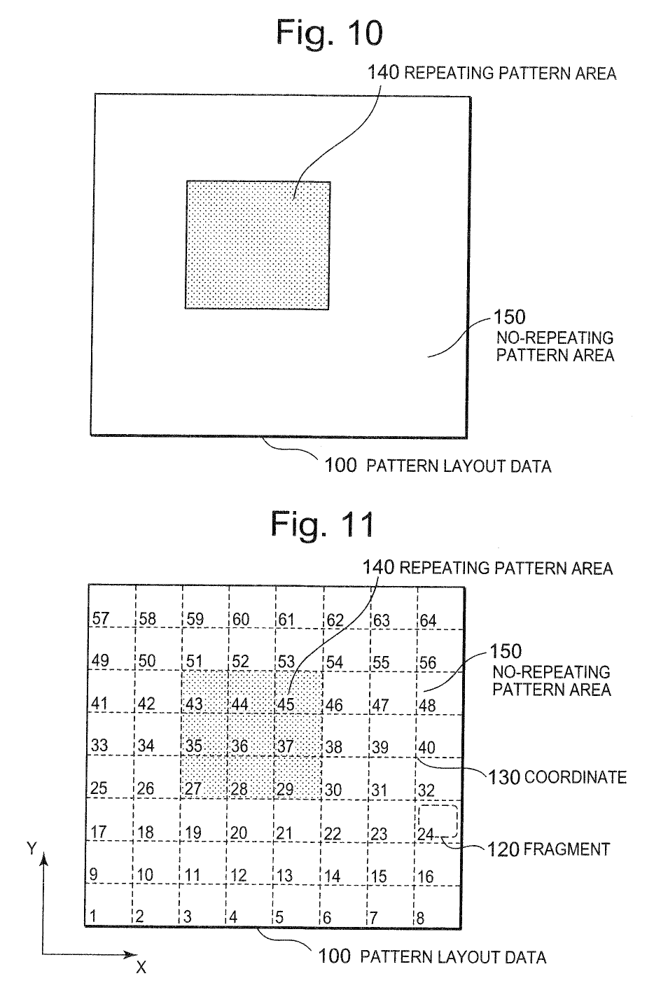

In the second embodiment, description will be performed on the basis of FIG. 3. In FIG. 3, the kind of repetitive unit cells is three. However, in practice, there exist or more three kinds of devices such as repeating parts of plural transistors, repeating parts of plural decoupling capacitors and repeating parts of plural dummy areas. Since these repeating parts are arranged, e.g., as shown in FIG. 9, if OPC calculation is performed with respect to unit cells, it is sufficient to arrange the OPC calculated cell. For this reason, large reduction of calculation time can be realized. In the second embodiment, the part different from the embodiment 1 will be mainly described using FIG. 3 with respect to a calculation method in which such repetitive cell is taken into consideration.

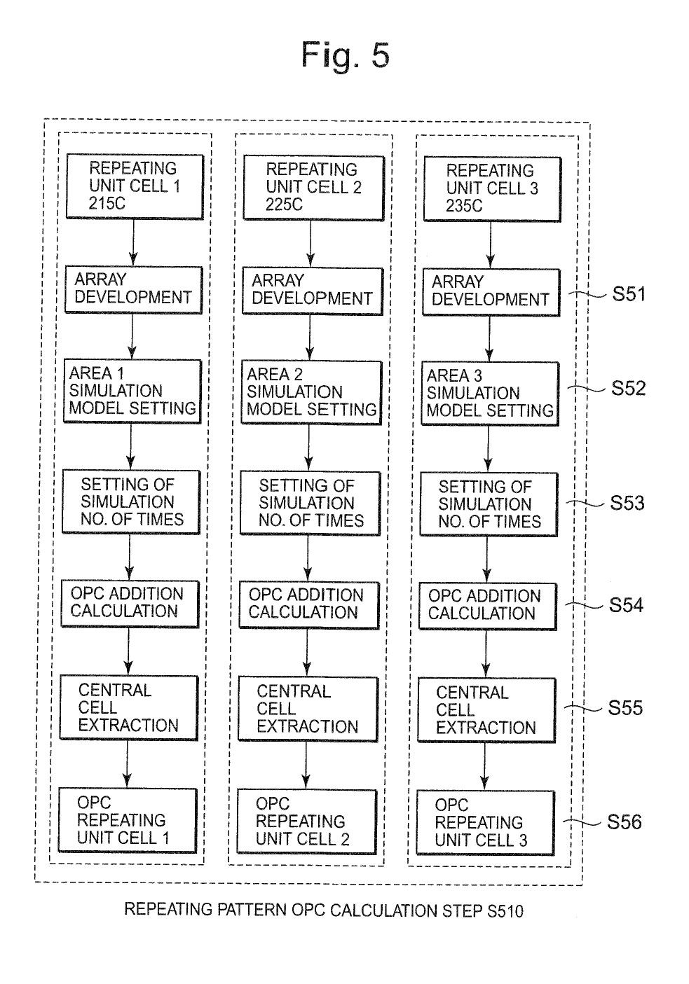

In the embodiment 2, sequential simulation (repetition) with respect to fragments of all pattern layouts is not performed. For this reason, since management of repetitive cells is performed in pattern layout by arrangement representation of unit cells, an area where management is performed by arrangement representation of the unit cells is included into area layout data as layout of the repeating pattern area at the stage of chip layout, and the unit cells are extracted, on the other hand, from the pattern layout to perform repeating pattern OPC calculation step 510 (FIG. 5: S510) before calculation area setting of step 3.

In the repeating pattern OPC calculation step 510, repeating unit cells 1 are spread to such a degree that the central OPC calculation is not affected by the influence of the outer periphery (step 51 (S51): array development),setting a simulation model and the number of repetition times which correspond to the accuracy of the area where repeating unit cells 1 are array-developed area (steps 52 to 53: S52-53) performing OPC calculation (step 54: S54) extracting the central cell (step 55: S55), and allowing the central cell thus extracted to be repeating unit cell 1 with OPC (step 56: S56). Here, the OPC thus determined is replaced into cells of uncalculated area after calculation of OPC of the no-repeating pattern unit has been completed (step 11 in FIG. 3). This calculation is performed similarly to repeating unit cells 2, 3 . . . in accordance with the kind of repeating unit cells. Here, the repeating unit cell 1, the repeating unit cell 2 and the repeating unit cell 3 are respectively, e.g., transistor repeating unit cell, decoupling capacitor repeating unit cell and dummy repeating unit cell In this case, as the simulation model, when the repeating unit cell is transistor cell, the simulation model of the area where the transistor cells are developed is employed. When the repeating unit cell is decoupling capacitor cell, the simulation model of the area where the decoupling capacitor cells are developed is employed.

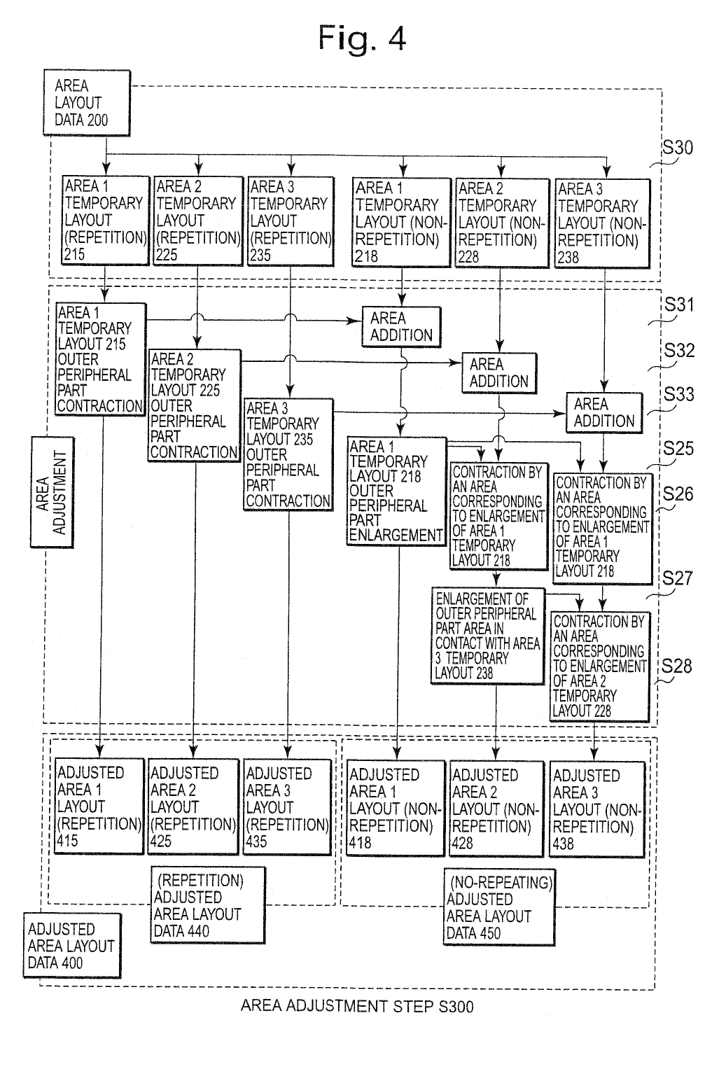

The area adjustment step of the embodiment 2 results in an area adjustment step 300 in which repeating pattern area 140 is taken into consideration. The flow of the area adjustment step 300 (S300) is shown in FIG. 4. In the area adjustment step 300, with respect to the repeating pattern area, respective outer peripheral parts of repeating pattern area temporary layouts 215, 225, 235 corresponding to the transistor area, the decoupling capacitor area and the dummy area, etc. are respectively contracted by predetermined areas on the boundary between the repeating pattern area and the no-repeating pattern area. These contraction values are added to accuracy areas respectively corresponding to the no-repeating pattern areas. Thus, the area adjustment is performed with respect to the no-repeating pattern area by enlarging the outer peripheral part of the high accuracy area by an area corresponding to accuracy, and by contracting the low accuracy area similarly to the area adjustment step 200. Here, a predetermined area in the area adjustment between repeating pattern area and no-repeating pattern area is an area determined by dimensions of unit cell, and is set as a value of integral multiple thereof, e.g., value of one to five times. Moreover, it is desirable that the value of this integral multiple is set by exposure condition in using, for exposure, a mask produced by this embodiment and accuracy of an area based on a cell to be calculated. In the area adjustment step of the no-repeating pattern area, area adjustment is performed similarly to the embodiment 1. By the area adjustment step 300, there is generated area layout data 400 including repeating area layout data 440 after area adjustment and no-repeating area layout data 450 after area adjustment.

The calculation area setting of the step 3 is performed similarly to the embodiment 1. Next, there is determined by referring to the area data 400 after area adjustment, which is obtained in the area adjustment step 300 whether or not the fragment exists at repeating pattern area layout data 440 (step 4). When it is determined in this step 4 that fragment of division number 1 (FIG. 11) does not exist at the repeating pattern area layout data 440 after area adjustment (NO), accuracy classification is performed in accuracy classification step based on an area by referring to the no-repeating area layout data 450 after area adjustment (step 5). Subsequently, OPC calculation is performed on the basis of the accuracy classification (steps 6 to 8). On the other hand, it is assumed that fragment of division number 36 exists in repeating pattern area 140, and exists at the repeating pattern area layout data 440 after area adjustment also after the area adjustment step 300 is performed. In this case, since determination result is YES by the repeating pattern area determination of the step 4 so that no calculation is performed, there remains pattern data to which no OPC is newly added. In a manner as stated above, there is performed, in order, with respect to fragment, a flow in which, in the steps 4 to 10 of the embodiment 2, OPC is newly added to only fragment determined in the area adjustment step 300 so that it exists at the no-repeating area layout data after area adjustment, and the repeating pattern area is left as uncalculated area part.

By developing arrangement of unit cells prepared in step 510 to replace the uncalculated area part by the developed unit cells, OPC pattern output of all areas is completed (step 11: S11). This replacement is performed by referring to the repeating area layout data 440 after area adjustment.

The meaning of the embodiment 2 will be described. At the inside of the repeating pattern area, the same OPC calculations are performed within all unit cells. However, the unit cell in the vicinity of the boundary undergoes the influence of the periphery thereof, and there thus results an OPC pattern different from that of the inside. For this reason, when the same OPC calculation as that of the inside is performed also at the outer peripheral part of the repeating pattern area as it is, discontinuous OPC patterns are formed at the boundary part. In view of the above, the OPC calculation of the repeating pattern area outside is driven to be performed without regarding the outer peripheral part of the repeating pattern area as a repeating pattern area, thereby making it possible to obtain an OPC pattern continuous at the boundary part.

### Modified Example of the Second Embodiment

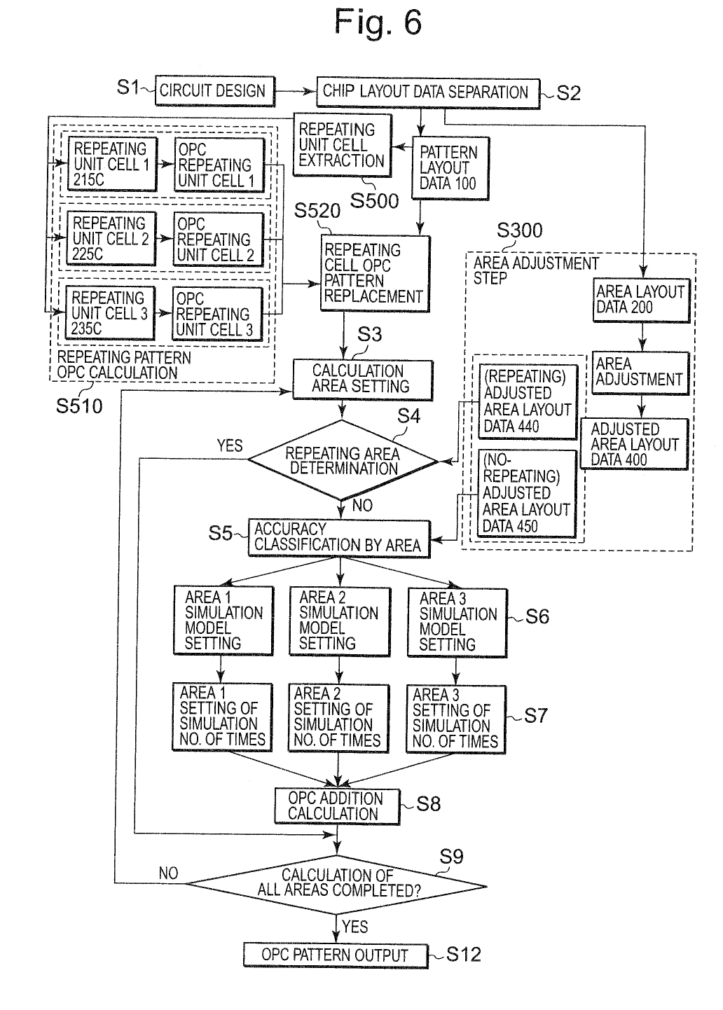

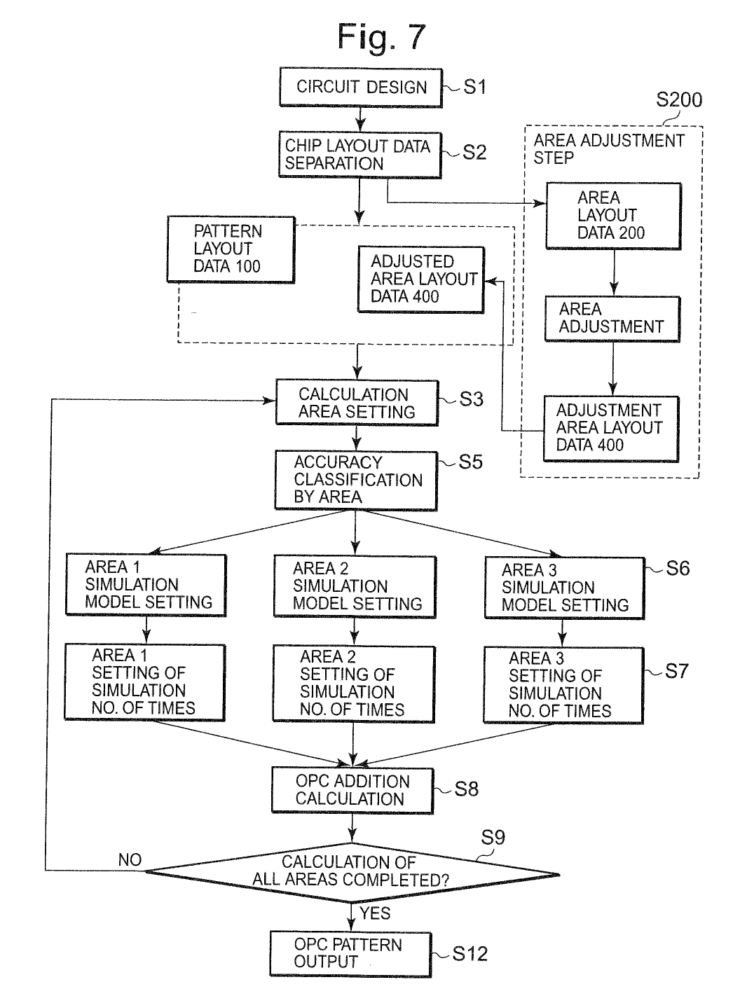

A modified example of the embodiment 2 is shown in FIG. 6. This modified example differs from the embodiment 2 in that calculation result by repeating pattern OPC calculation step 510 (S510) is replaced in advance in step 520 (S520) before the entire OPC calculation is performed. In this case, to what degree repeating/no-repeating patterns are discontinuously connected at the boundary therebetween becomes small. The reason thereof is as follows. In the case where OPC pattern is used, the exposure condition therearound also affects the OPC pattern. For this reason, in the case where unit cell after OPC calculation exists at the part serving as the periphery of the boundary, OPC calculation is not applied to the cell itself. However, since corresponding cell becomes proximity to the part where OPC calculation is implemented, such an effect takes place.

### Third Embodiment

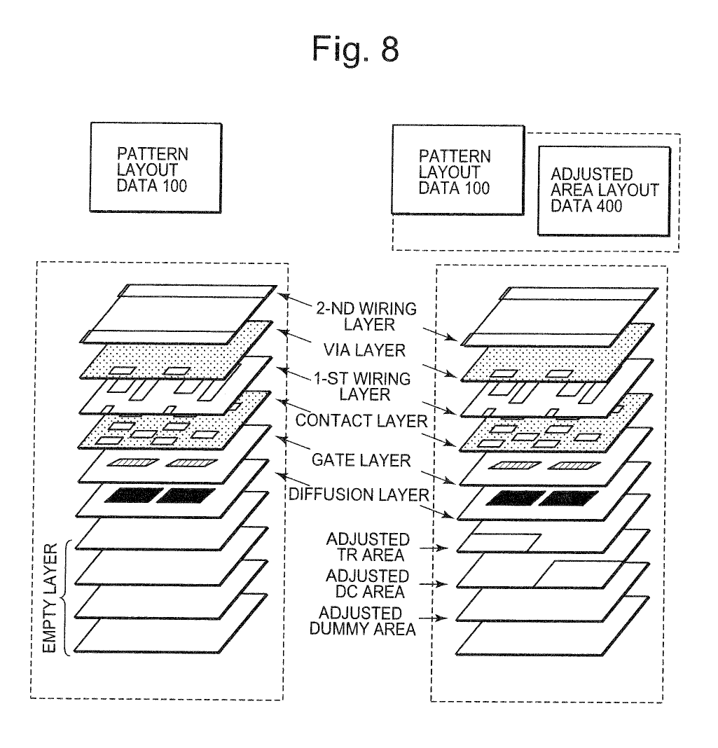

The part different from the first embodiment will be mainly described. In the third embodiment, in place of preserving area layout data after area adjustment, which is obtained in area adjustment step 200 by itself, such an adjusted layout data is preserved along with pattern layout data. This preserving method is shown in FIG. 8. In this method, in order to handle area layout in the form of pattern layout data, such area layout is contained into an empty layer of pattern layout data.

The advantage of the third embodiment is that management of change of area layout followed by design change is easy, and there is no necessity to read different file in computation. Although the flow for mask data formation is the same as that of the first embodiment, advantages based on such a configuration are as follows. When the human being verifies the effect of OPC pattern, e.g., confirms change of OPC accuracy, it can be easily determined by looking at two layers in the state where they overlap with each other that a corresponding area is, e.g., transistor area and OPC accuracy necessary therefor is given. Moreover, in the case where the area layout is separated into file different from pattern layout, if there exists a version taking place resulting from the fact that accuracy or model of OPC is changed, there is the possibility that there takes place such an erroneous operation to perform OPC calculation in the area layout and the pattern layout which are not the same in version. However, when those layouts are incorporated into a single file, such an erroneous operation does not take place.

The third embodiment can be applied not only to the first embodiment, but also to the second embodiment and the modified example thereof. In the case applied to the second embodiment and the modified example thereof, there results a form in which adjusted layout data 400 obtained in area adjustment step 300 is preserved within pattern layout data.

While the configurations of the present invention have been described above, a configuration or configurations obtained by arbitrarily combining these configurations may be also effective as a form of the present invention.

What is claimed is:

1. A mask data generation method comprising:
dividing design data for exposure mask into pattern layout data and area layout data;
classifying the area layout data in accordance with accuracies of a first area layout data and a second area layout data being lower accuracy than the first area layout data;
adjusting boundary part between the first and second area to enlarge the first area into a second area and to contract the second area with predetermined area based on accuracy of the first area in a range which is smaller than the maximum value of an influence range of proximity effect to form first and second adjusted layout data; and
performing optical proximity correction corresponding to each accuracy of the adjusted first and second area layout data.

2. The mask data generation method according to claim 1,
wherein performing the optical proximity correction comprises:
dividing the pattern layout data to set a fragment subject to simulation;
performing accuracy classification of the fragment on the basis of the adjusted layout data;
correcting the accuracy-classified plural fragments by using correction parameters based on accuracies of areas to which the respective fragments belong to form plural corrected fragments; and
synthesizing the plural corrected fragments.

3. A mask data generation method comprising:
dividing design data for exposure mask into pattern layout data and area layout data;
classifying the area layout data into repeating pattern area layout data and no-repeating pattern area layout data;
classifying the repeating area layout data in accordance with accuracies of a first area layout data and a second area layout data being lower accuracy than the first area layout data;
classifying the no-repeating area layout data in accordance with accuracies of a first area layout data and a second area layout data being lower accuracy than the first area layout data;
adjusting boundary part in accordance with accuracy of each area between the repeating and no-repeating pattern area to contract the repeating pattern area layout data and to enlarge the no-repeating pattern area layout data with predetermined area based on repeating pattern thereof;
adjusting boundary part of no-repeating area between first and second area to enlarge the first area into a second area and to contract the second area with predetermined area based on accuracy of the first area in a range which is smaller than the maximum value of an influence range of proximity effect to form first and second adjusted layout data;
extracting repeating unit cell from the pattern layout data;
developing the extracted unit cell into an array to perform correction;
extracting a corrected unit cell after performing correction using a correction parameter corresponding to an area developed into the array;
performing optical proximity correction corresponding to each accuracy of the adjusted first and second area layout data; and
replacing the corrected unit cell by referring to the adjusted area layout data of the repeating pattern area.

4. The mask data generation method according to claim 3,
wherein the corrected unit cell is replaced after optical proximity correction of the no-repeating pattern area has been made.

5. The mask data generation method according to claim 3,
wherein the corrected unit cell is replaced before optical proximity correction of the no-repeating pattern area is made.

6. The mask data generation method according to claim 3,
wherein performing the optical proximity correction comprises:
dividing the pattern layout data to set a fragment;
determining on the basis of the adjusted layout data of the repeating pattern area whether or not the fragment is data existing in the repeating pattern area;
performing accuracy classification of the fragment determined in the determination step so that it is not data existing in the repeating pattern area on the basis of the adjusted layout data of the no-repeating pattern area;
performing correction of the accuracy-classified plural fragments by using correction parameters based on accuracies of areas to which the respective fragments belong to form plural corrected fragments; and
synthesizing the plural corrected fragments.

7. The mask data generation method according to claim 1,
wherein the area layout data includes at least one of transistor area data, decoupling capacitor area data and dummy area data.

8. The mask data generation method according to claim 1,
wherein the adjusted area layout data is preserved in an empty layer of pattern layout data.

9. The mask data generation method according to claim 1,
wherein a pattern subject to optical proximity correction included in the first and second area is a line pattern.

10. The mask data generation method according to claim 9,
wherein enlargement and contraction corresponding to the predetermined area based on accuracy of the first area are performed within two pitches.

11. The mask data generation method according to claim 1,
wherein a pattern subject to optical proximity correction included in the first and second area a hole pattern.

12. The mask data generation method according to claim 11,
wherein enlargement and contraction corresponding to the predetermined area based on accuracy of the first area are performed within two pitches.

13. The mask data generation method according to claim 1,
wherein a pattern subject to optical proximity correction included in the first area is a line pattern and a pattern subject to optical proximity correction included in the second area is a hole pattern.

14. The mask data generation method according to claim 13,
wherein enlargement and contraction corresponding to the predetermined area based on accuracy of the first area are performed within two pitches.

15. A mask formation method wherein mask data obtained by the mask data generation method of claims 1 is acquired to form a pattern on a mask substrate on the basis of the mask data.

16. A pattern formation method including:
forming a resist film on a substrate;
exposing the resist film by using a mask formed by the mask formation method according to claim 15 thereby form a resist pattern; and
performing etching using the resist pattern as a mask.

17. A mask data generation method comprising:
dividing exposure mask data into pattern layout data and area layout data;
enlarging the first area layout data by a predetermined range to produce first enlarged area layout data while contacting the second area layout data by the predetermined area to produce, the predetermined range being smaller than a maximum influence range of proximity effect; and
performing first optical proximity correction on the pattern layout data contained in the first enlarged area layout data and second optical proximity correction on the pattern layout data contained in the second enlarged area layout data.
